(19) United States
(12) Patent Application Publication
(10) Pub. No.: US 2021/0165999 A1
(43) Pub. Date: Jun. 3, 2021

(54) METHOD AND SYSTEM FOR HEAD POSE ESTIMATION

(71) Applicant: IEE INTERNATIONAL ELECTRONICS & ENGINEERING S.A., Echternach (LU)

(72) Inventors: Bruno MIRBACH, Konz (DE); Frederic GARCIA BECERRO, Belvaux (LU); Jilliam Maria DIAZ BARROS, Kaiserlautern (DE)

(21) Appl. No.: 16/632,689

(22) PCT Filed: Jul. 25, 2018
(86) PCT No.: PCT/EP2018/070205

§ 371 Date: Jan. 21, 2020

(30) Foreign Application Priority Data
Jul. 25, 2017 (LU) 100 348

(51) Int. Cl. G06K 9/00; G06T 7/73; G06K 9/46; G06K 9/58

(52) U.S. Cl. CPC G06K 9/00248; G06T 7/75; G06T 2207/30201; G06K 9/00281; G06K 9/58; G06K 9/4676

(57) ABSTRACT

A method for head pose estimation using a monocular camera. The method includes: providing an initial image frame recorded by the camera showing a head; and performing at least one pose updating loop with the following steps: identifying and selecting of a plurality of salient points of the head having 2D coordinates in the initial image frame within a region of interest; determining 3D coordinates for the selected salient points using a geometric head model of the head, corresponding to a head pose; providing an updated image frame recorded by the camera showing the head; identifying within the updated image frame at least some previously selected salient points having updated 2D coordinates; updating the head pose by determining updated 3D coordinates corresponding to the updated 2D coordinates using a perspective-n-point method; and using the updated image frame as the initial image frame for the next pose updating loop.

### TECHNICAL FIELD

The present invention relates method and a system for head pose estimation.

### BACKGROUND OF THE INVENTION

Head pose estimation (HPE) is required for different kinds of applications. Apart from determining the head pose itself, HPE is often necessary for face recognition, detection of facial expression, gaze or the like. Many of these applications are safety-relevant, e.g. if the head pose of a driver is detected in order to determine whether he is tired or distracted. However, detecting and monitoring the pose of a human head based on camera images is a challenging task. This applies especially if a monocular camera system is used. In general, the head pose can be characterized by 6 degrees of freedom (DOF), namely 3 for translation and 3 for rotation. For most applications, these 6 DOF need to be determined or estimated in real-time. Some of the problems encountered with head pose estimation are that the human head is geometrically rather complex, individual heads differ significantly (in size, proportions, color etc.) and the illumination may significant influence on the appearance of the head.

In general, HPE approaches intended for monocular camera systems are based on geometric head models and the tracking of feature points on the head model in the image. Feature points may be facial landmarks (e.g. eyes, nose or mouth) or arbitrary points on the person's face. Thus, these approaches rely either on a precise detection of facial landmarks or a frame-to-frame face detection. The main drawback of these methods is that they may fail at large rotation angles of the head when facial landmarks become occluded to the camera. Methods based on tracking arbitrary features on the face surface may cope with larger rotations, but tracking of these features is often unstable, e.g. due to low texture or changing illumination. In addition, the face detection at large rotation angles is also less reliable than in a frontal view. Although there have been several approaches to address these drawbacks, the fundamental problem remains unsolved so far, namely that a frame-to-frame detection of the face or facial landmarks is required.

### SUMMARY

It is an object of the present invention to provide means for reliable and robust real-time head pose estimation. The object is achieved by a method and/or system according to the claims.

In accordance with an aspect of the present invention, there is provided a method for head pose estimation using a monocular camera. In the context, “estimating” the head pose and “determining” the head pose are used synonymously. It is understood that whenever a head pose is determined based on images alone, there is some room for inaccuracy, making this an estimation of the head pose. The method uses a monocular camera, which means that only images from a single viewpoint are available at a time. However, it is conceivable that the monocular camera itself changes its position and/or orientation while the method is performed. “Head” in this context mostly refers to a human head, although it is conceivable to apply the method to HPE of an animal head.

In a first step, an initial image frame recorded by the camera is provided, which initial image frame shows a head. It is understood that the image frame is normally provided as a sequence of (digital) data representing pixels. The initial image frame represents everything in the field of view of the camera, and a part of the initial image frame is an image of a head. Normally, the initial image frame should show the entire head, although the inventive method may also work if e.g. the person is so close to the camera that only a part of the head (e.g. 80%) are visible. In general, the initial image frame may be monochrome or multicolor.

After the initial image frame has been provided, an initial head pose may be obtained. This initial head pose may be determined from the initial image frame based on a pre-defined geometrical head model as is described below. Alternatively the method could use an externally determined initial head pose to be provided as will be described later. Subsequently, at least one pose estimation loop is performed. However, it should be noted that the pose estimation loop does not have to be performed immediately afterwards. For example, if the camera is recording a series of image frames e.g. at 50 frames per second or 100 frames per second, the pose estimation loop does not have to be performed for the image frame that follows the initial image frame. Rather it is possible that several frames or even several tens of frames have passed since the initial image frame. Each pose estimation loop comprises the following steps, which do not necessarily have to be performed in the order they are mentioned.

In one step, a plurality of salient points of the head having 2D coordinates in the initial image frame within a region of interest are identified and selected. Salient points (or salient features) are points that are in some way clearly distinguishable from their surroundings, mostly due to a clear contrast in color or brightness. Mostly they are part of a textured region. Examples for salient points are corners of an eye or a mouth, features of an ear, birthmarks, piercings or the like. In order to detect these salient points, algorithms known in the art may be employed, e.g. Harris Corner detection, SIFT, SURF or FAST. A plurality of such salient points is identified and selected. This includes the possibility that some salient points are identified but not selected (i.e. discarded), for example because they are considered to be less suitable for the following steps of the method. The region of interest is that part of the initial image frame that is considered to show the head or at least part of the head. In other words, identification and selection of salient points is restricted to this region of interest. The time interval between recording the initial image frame and selecting the plurality of salient points can be short or long. However, for real-time applications, it is mostly desirable that the time interval is short, e.g. less than 10 ms. In general, identification of the salient points is not restricted to the person's face. For instance when the head is rotated, the region of interest comprises, at least in one loop, a non-facial region of the head. In that case, at least in one loop, at least one selected salient point is in a non-facial region of the head. Such a salient point may be e.g. a feature of an ear, an ear ring or the like. Not being restricted to detecting facial features is a great advantage of the inventive method which makes frame-to-frame detection of the face unnecessary.

After the salient points have been selected, corresponding 3D coordinates are determined using a geometric head model of the head, corresponding to a head pose. It will be understood that the 3D coordinates which are determined are the 3D coordinates of the salient points of the 3D geometric head model of the current head pose. In other words, starting from the 2D coordinates (in the initial image frame) of the salient points, 3D coordinates in the 3D space (or in the “real world”) are determined (or estimated). Of course, without additional information, the 3D coordinates would be ambiguous. In order to resolve this ambiguity, a geometric head model is used which defines the size and shape of the head (normally in a simplified way) and a head pose is assumed, which defines 6 DOF of the head, i.e. its position and orientation. The skilled person will appreciate that the geometric head model is the same for all poses, but not its configuration (orientation+location). It is further understood that the (initial) head pose has to be predetermined in some way. While it is conceivable to approximately determine the position of the head e.g. by assuming an average size and relating this to the size of the initial image, it is rather difficult to estimate the orientation. One possibility is to consider the 3D facial features of an initial head model. Using a perspective-n-point method, the head pose that relates these 3D facial features with their corresponding 2D facial features detected in the image is estimated. However, this initialization requires the detection of a sufficient number of 2D facial features in the image, which might not be always guaranteed. To resolve this problem, a person may be asked to face the camera directly (or assume some other well-defined position) when the initial image frame is recorded. Alternatively one could use a method which determines in which frame the person is looking forward into the camera and to use this frame as the initial image frame. As this step is completed, the salient points are associated with 3D coordinates which are located on the head as represented by the (usually simplified) geometric head model.

In another step, an updated image frame recorded by the camera showing the head is provided. This updated image frame has been recorded after the initial image frame, but as mentioned above, it does not have to be the following frame. In contrast to methods known in the art, the inventive method works satisfyingly even if several image frames have passed from the initial image frame to the updated image frame. This of course implies the possibility that the updated image frame differs considerably from the initial image frame and that the pose of the head may have changed significantly.

After the updated image frame has been provided, at least some previously selected salient points having updated 2D coordinates are identified within the updated image frame. The salient points may e.g. be tracked from the initial image frame to the updated image frame. However other feature registration methods are also possible. One possibility would be to determine salient points in the updated image frame and to register the determined salient points in the updated image frame to salient points in the initial image frame. The identification of the salient points having updated 2D coordinates may be performed before or after the 3D coordinates are determined or at the same time, i.e. in parallel. Normally, since the head pose has changed between the initial image frame and the updated image frame, the updated 2D coordinates differ from the initially identified 2D coordinates. Also, it is possible that some of the previously selected salient points are not visible in the updated image frame, usually because the person has turned his head so that some salient points are no longer facing the camera or because some salient points are occluded by an object between the camera and the head. However, if enough salient points have been selected before, a sufficient number should still be visible. These salient points are identified along with their updated 2D coordinates.

Once the salient points have been identified and the updated 2D coordinates are known, the head pose is updated by determining updated 3D coordinates corresponding to the updated 2D coordinates using a perspective-n-point method. In general, perspective-n-point is the problem of estimating the pose of a calibrated camera given a set of n 3D points in the world and their corresponding 2D projections in the image. However, this is equivalent to the pose of the head being unknown with respect to the camera, when n salient points of the head with 3D coordinates are given. Of course, the method is based on the assumption that the positions of the salient points with respect to the geometric head model do not change significantly. Although the head with its salient points is not completely rigid and the relative positions of the salient points may change to some extent (e.g. due to changes in facial expression), it is generally still possible to solve the perspective-n-point problem, while changes in the relative positions can lead to some discrepancies which can be minimized to determine the most probable head pose. The big advantage of employing a perspective-n-point method in order to determine the updated 3D coordinates and thus the updated head pose is that this method works even if larger changes occur between the initial image frame and the updated image frame. It is not necessary to perform a frame-by-frame tracking of the head or the salient points. As long as a sufficient number of previously selected salient points can be identified in the updated image frame, the head pose can always be updated.

If more than one pose updating loop is performed, the updated image frame is used as the initial image frame for the next loop.

While it is possible that the parameters of the geometric head model and the head pose are provided externally, e.g. by manual or voice input, some of these may be determined (or estimated) using the camera. For instance it is possible that before performing the at least one pose updating loop, a distance between the camera and the head is determined. The distance is determined using an image frame recorded by the camera, e.g. the initial image frame. For example, if the person is facing the camera, the distance between the centers of the eyes in the image frame may be determined. When this is compared with the mean interpupillary distance, which corresponds to 64.7 mm for male and 62.3 mm for female according to anthropometric databases, the ratio of the these distances is equal to the ratio of a focal length of the camera and the distance between the camera and the head, or rather the distance between the camera and the baseline of the eyes. If the dimensions of the head, or rather the geometric head model, are known, it is possible to determine the 3D coordinates of the center of the head, whereby 3 of the 6 DOF of the head pose are known.

It is also preferred that before performing the at least one pose updating loop, dimensions of the head model are determined. How this is performed depends of course on the head model used. In the case of a cylindrical head model, a bounding box of the head within the image frame may be determined, the height of which corresponds to the height of the cylinder, assuming that the head is not inclined, e.g. when the person is facing the camera. The width of the bounding box corresponds to the diameter of the cylinder. It is understood that in order to determine the actual height and diameter (or radius), the distance between the camera and the head has to be known, too.

The head model normally represents a simplified geometric shape. This may be e.g. an ellipsoidal head model (EHM) or even a plane head model (PHM). According to one embodiment, the head model is a cylindrical head model (CHM). In other words, the shape of the head is approximated as a cylinder. While this model is simple and allows for easy identification of the visible portions of the surface, it is still a sufficiently good approximation to yield reliable results. However, other more accurate models may be used to advantage, too.

Normally, the method is used to monitor a changing head pose over a certain period of time. Thus, it is preferred that a plurality of consecutive pose updating loops are performed.

There are different options how to identify previously selected salient points. The general problem may be regarded as tracking the salient points from the initial image frame to the updated image frame. There are several approaches to such an optical tracking problem. According to one preferred embodiment, previously selected salient points are identified using optical flow. This may be performed, for example, using the Kanade-Lucas-Tomasi (KLT) feature tracker as disclosed in J. Y. Bouget, “Pyramidal implementation of the affine lucas kanade feature tracker description of the algorithm”, Intel Corporation, 2001, vol. 1, No. 2, pp. 1-9. It will of course be appreciated, that instead of tracking the salient points other feature registration methods are also possible. One possibility would be to determine salient points in the updated image frame and to register the determined salient points in the updated image frame to salient points in the initial image frame.

Preferably, the 3D coordinates are determined by projecting 2D coordinates from an image plane of the camera onto a visible head surface. The image plane of the camera may correspond to the position of a CCD element or the like. This may be regarded as the physical location of the image frames. Given the optical characteristics of the camera, it is possible to project or “ray trace” any point on the image plane to its origin, if the surface of the corresponding object is known. In this case, a visible head surface is provided and the 3D coordinates correspond to the intersection of a back-traced ray with this visible head surface. The visible head surface represents those parts of the head that are considered to be visible. It is understood that depending on the head model used, the actually visible surface of the (real) head may differ more or less.

According to a preferred embodiment, the visible head surface is determined by determining the intersection of a boundary plane with a model head surface. The model head surface is a surface of the used geometric head model. In the case of a CHM, the model head surface is a cylindrical surface. The boundary plane is used to separate the part of the model head surface that is considered to be invisible (or occluded) from the part that is considered to be visible. The accuracy of the thus determined visible head surface partially depends on the head model, but for a CHM, the result is adequate if the location and orientation of the boundary plane are determined appropriately.

Preferably, the boundary plane is parallel to an X-axis of the camera and a center axis of the cylindrical head model. Herein, the X-axis is a horizontal axis perpendicular to the optical axis. In the corresponding coordinate system, the Z-axis corresponds to the optical axis and the Y-axis to the vertical axis. Of course, the respective axes are horizontal/vertical within the reference frame of the camera, and not necessarily with respect to the direction of gravity. The center axis of the cylindrical head model runs through the centers of each base of the cylinder. In other words, it is the symmetry axis of the cylinder. One can also say that the normal vector of the boundary plane results from the cross-product of the X-axis and the center axis. The intersection of this boundary plane and the (cylindrical) model head surface defines the (three-dimensional) edges of the visible head surface.

It will be noted that the region of interest may be determined from the image frame by any suitable method known by the skilled person. According to one embodiment, the region of interest is defined by projecting the visible head surface onto the image plane. The intersection of the boundary plane and the (cylindrical) model head surface defines the (three-dimensional) edges of the visible head surface. Projecting these edges onto the image plane of the camera yields the corresponding 2D coordinates in the image. These correspond to the (current or updated) region of interest. As mentioned above, e.g. when the head is rotated, the region of interest comprises, at least in one loop, a non-facial region of the head. In that case, at least in one loop, the visible head surface comprises a non-facial head surface.

According to a preferred embodiment, the salient points are selected based on an associated weight which depends on the distance to a border of the region of interest. This is based on the assumption that salient points which are close to the border of the region of interest may possibly not belong to the actual head or may be more likely to become occluded even if the head pose changes only slightly. For example, one such salient point could belong to person's ear and thus be visible when the person is facing the camera, but become occluded even if the person turns his head only slightly. Therefore, if enough salient points are detected further away from the border of the region of interest, salient points closer to the border could be discarded.

Also, the perspective-n-point method may be performed based on the weight of the salient points. For example, if the result of the perspective-n-point method is inconclusive, those salient points which had been detected closer to the border of the region of interest could be neglected completely or any inconsistencies in the determination of the updated 3D coordinates associated with these salient points could be tolerated. In other words, when determining the updated head pose, the salient points further away from the border are treated as more reliable and with greater weight. This approach can also be referred to as “distance transform”.

If several consecutive pose updating loops are performed, the initially specified region of interest is normally not suitable any more after some time. This would lead to difficulties when updating the salient points because detection would occur in a region of the image frame that does not correspond well with the position of the head. It is therefore preferred that in each pose updating loop, the region of interest is updated. Normally, updating the region of interest is performed after updating the head pose.

In another aspect of the invention, there is provided a system for head pose estimation, comprising a monocular camera and a processing device, which is configured to:
receive an initial image frame recorded by the camera showing a head; and
perform at least one pose updating loop with the following steps:
identifying and selecting of a plurality of salient points of the head having 2D coordinates in the initial image frame within a region of interest;
determining corresponding 3D coordinates using a geometric head model of the head corresponding to a head pose;
receiving an updated image frame recorded by the camera showing the head;
identifying within the updated image frame at least some previously selected salient points having updated 2D coordinates;
updating the head pose by determining updated 3D coordinates corresponding to the updated 2D coordinates using a perspective-n-point method; and
using the updated image frame as the initial image frame for the next pose updating loop.

The processing device can be connected to the camera with a wired or wireless connection in order to receive image frames from the camera and, optionally, to transmit commands to the camera. It is understood that normally at least some functions of the processing device are software-implemented.

Other terms and functions performed by the processing device have been described above with respect to the corresponding method and therefore will not be explained again.

Preferred embodiments of the inventive system correspond to those of the inventive method. In other words, the system, or normally, the processing device of the system, is preferably adapted to perform the preferred embodiments of the inventive method.

### BRIEF DESCRIPTION OF THE DRAWINGS

Further details and advantages of the present invention will be apparent from the following detailed description of not limiting embodiments with reference to the attached drawing, wherein:

FIG. 1 is a schematic representation of an inventive system and a head;

FIG. 2 is a flowchart illustrating an embodiment of the inventive method;

FIG. 3 illustrates a first initialization step of the method of FIG. 2;

FIG. 4 illustrates a second initialization step of the method of FIG. 2; and

FIG. 5 illustrates a sequence of steps of the method of FIG. 2.

### DESCRIPTION OF THE ILLUSTRATED EMBODIMENTS

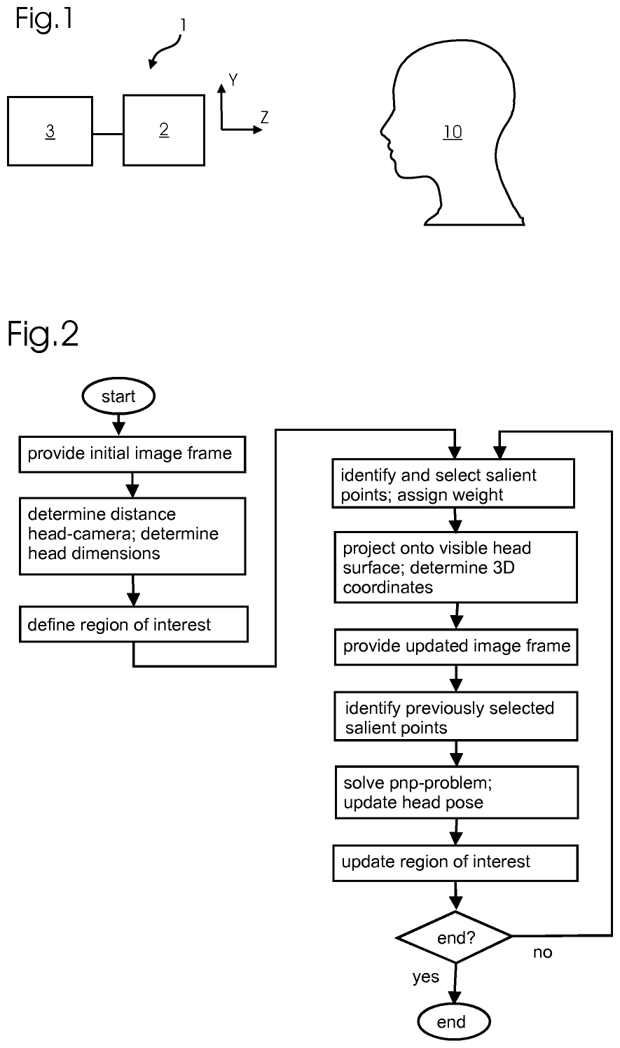

FIG. 1 schematically shows a system 1 for head pose estimation according to an embodiment of the invention and a head 10 of a person. The system 1 comprises a monocular camera 2 which may be characterized by a vertical Y-axis, a horizontal Z-axis, which corresponds to the optical axis, and a X-axis which is perpendicular to the drawing plane of FIG. 1. The camera 2 is connected (by wire or wirelessly) to a processing device 3, which may receive image frames I₀, Iₙ, Iₙ₊₁ recorded by the camera 2. The camera 2 is directed towards the head 10. The system 1 is configured to perform a method for head pose estimation, which will now be explained with reference to FIGS. 2 to 5.

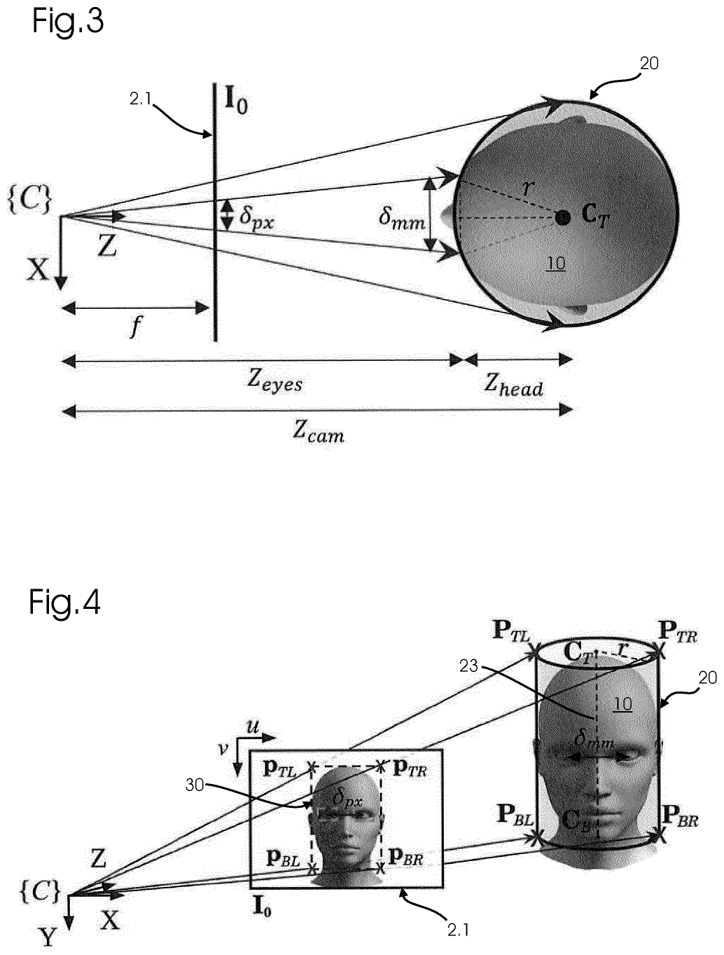

FIG. 2 is a flowchart illustrating one embodiment of the inventive method. After the start, an initial image frame I₀ is recorded by the camera as shown in FIGS. 3 and 4. The “physical location” of any image frame corresponds to an image plane 2.1 of the camera 2. The initial image frame I₀ is provided to the processing device 3. In a following step, the processing device 3 determines a distance Z_{eyes} between the camera and the head 10, or rather between the camera and the baseline of the eyes, which (as illustrated by FIG. 3) is given by

$${Z}_{eyes} = f \frac{{δ}_{mm}}{{δ}_{px}} ,$$

with f being the focal length of the camera in pixels, δₚₓ the estimated distance between the eye's centers on the image frame I₀, and δₘₘ the mean interpupillary distance, which corresponds to 64.7 mm for male and 62.3 mm for female according to anthropometric databases. As shown in FIGS. 3 to 5, the real head 10 is approximated by a cylindrical head model (CHM) 20. During initialization, the head 10 is supposed to be in a vertical position and facing the camera 2, wherefore the CHM 20 is also upright with its center axis 23 parallel to the Y-axis of the camera 2. The center axis 23 runs through the centers C_{T}, C_{B} of the top and bottom bases of the CHM 20.

Z_{cam} denotes the distance between the center of the CHM 20 and the camera 2 and is equal to the sum of Z_{eyes} and the distance Z_{head} from the centre of the head 10 to the midpoint between the eyes' baseline. Z_{cam} is related to a radius r of the CHM by Z_{head}=\sqrt{r²−(δₘₘ/2)²}. As shown in FIG. 4, the dimensions of the CHM 20 may be determined by a bounding box in the image frame, which defines a region of interest 30. The height of the bounding box corresponds to the height of the CHM 20, while the width of the bounding box corresponds to the diameter of the CHM 20. Of course, the respective quantities in the image frame I₀ need to be scaled by a factor of

$$\frac{{δ}_{mm}}{{δ}_{px}}$$

in order to obtain the actual quantities in the 3D space. Given the 2D coordinates {p_{TL}, p_{TR}, p_{BL}, p_{BR}} of the top left, top right, bottom left and bottom right corners of the bounding box, the processing device 3 calculates

$$r = \frac{1}{2} \vert {p}_{TR} - {p}_{TL} \vert \frac{{δ}_{mm}}{{δ}_{px}} .$$

Similarly, the height h of the CHM 20 is calculated by

$$h = \vert {p}_{TR} - {p}_{BR} \vert \frac{{δ}_{mm}}{{δ}_{px}} .$$

With Z_{cam} determined (or estimated), the corners of the face bounding box in 3D space, i.e., {P_{TL}, P_{TR}, P_{BL}, P_{BR}} and the centers C_{T}, C_{B} of the top and bottom bases of the CHM 20 can be determined by projecting the corresponding 2D coordinates into 3D space and combining this with the information about Z_{cam}.

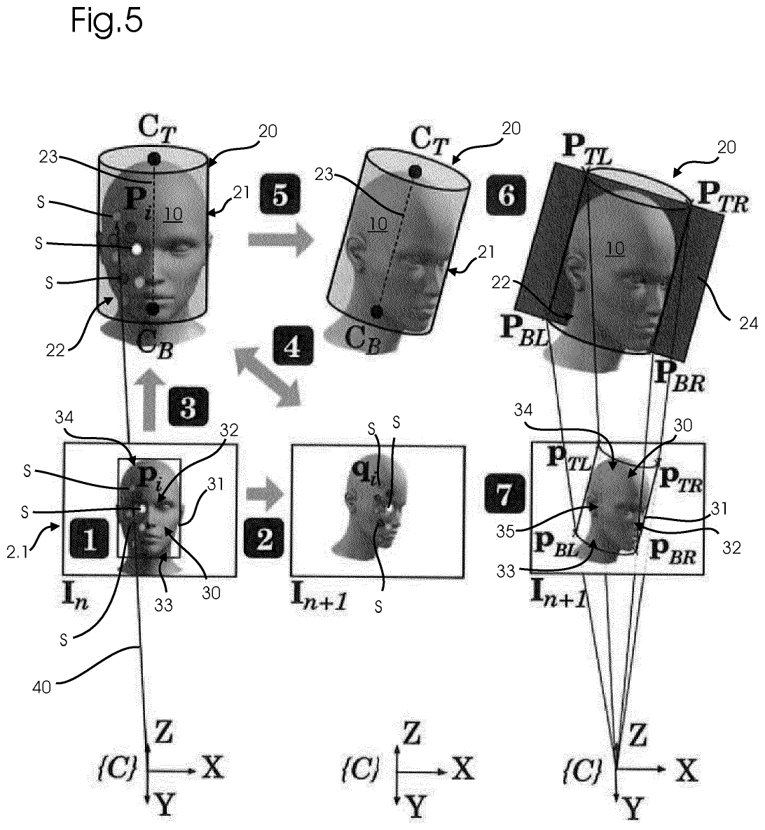

The steps described so far can be regarded as part of an initialization process. Once this is done, the method continues with the steps referring to the actual head pose estimation, which will now be described with reference to FIG. 5. The steps are part of a pose updating loop which is shown in the right half of FIG. 2.

While FIG. 5 shows an initial image frame Iₙ recorded by the camera 2 and provided to the processing device 3, this may be identical to the image frame I₀ in FIGS. 3 and 4. According to one step of the method performed by the processing device 3, a plurality of salient points S are identified within the region of interest 30 and selected (indicated by the white-on-black numeral 1 in FIG. 5). Such salient points S are located in textured regions of the initial image frame Iₙ and may be corners of an eye, of a mouth, of a nose or the like. In order to identify the salient points S, a suitable algorithm like FAST may be used. The salient points S are represented by 2D coordinates pi in the image frame I₀. A weight is assigned to each salient point S which depends on a distance of the salient point S from a border 31 of the region of interest 30. The closer the respective salient point S is to the border 31, the lower is its weight. It is possible that salient points S with the lowest weight are not selected, but discarded as being (rather) unreliable. This may serve to enhance the total performance of the method. It should be noted that the region of interest 30 comprises, apart from a facial region 32, several non-facial regions, e.g. a neck region 33, a head top region 34, a head side region 35 etc.

With the 2D coordinates pi of the selected salient points S known, corresponding 3D coordinates Pᵢ are determined (indicated by the white-on-black numeral 3 in FIG. 5). This is achieved by projecting the 2D coordinates onto a visible head surface 22 of the CHM 20. The visible head surface 22 is that part of a surface 21 of the CHM 20 that is considered to be visible for the camera 2. With the initial head pose of the CHM 20, the visible head surface 22 is one half of its side surface. The 3D coordinates Pᵢ may also be seen as the result of an intersection between a ray 40 starting at an optical center of the camera 2 and passing through the respective salient point S at the image plane 2.1, and the visible head surface 22 of the CHM 20. The equation of the ray 40 is defined as P=C+kV, with V being a vector parallel to the line that goes from the camera's optical center C through P. The scalar parameter k is computed by solving the quadratic equation of the geometric model.

In another step, and updated image frame Iₙ₊₁, which has been recorded by the camera 2, is provided to the processing device 3 and at least some of the previously selected salient points S are identified within this updated image frame Iₙ₊₁ (indicated by the white-on-black numeral 2 in FIG. 5) along with updated 2D coordinates qi. This identification may be performed using optical flow. While the labels in FIG. 5 indicate that identification within the updated image frame Iₙ₊₁ is performed before determining the 3D coordinates Pᵢ corresponding to the initial image frame Iₙ, the sequence of these steps may be inverted as indicated in the flowchart of FIG. 2 or they may be performed in parallel.

In another step (indicated by the white-on-black numeral 4 in FIG. 5), the processing device 3 uses the updated 2D coordinates qi and the 3D coordinates Pi to solve a perspective-n-point problem and thus, to update the head pose. The head pose is computed by calculating updated 3D coordinates P′ᵢ resulting from a translation t and rotation R, so that P′ᵢ=R·Pᵢ+t, and by minimizing the error between the reprojection of the 3D features onto the image plane and their respective detected 2D features by means of an iterative approach. In the definition of the error, it is also possible to take into account the weight associated with the respective salient point S, so that an error resulting from a salient point S with low weight contributes less to the total error. Applying the translation t and rotation R to the old head pose yields the updated head pose (indicated by the white-on-black numeral 5 in FIG. 5).

In another step, the region of interest 30 is updated. In this embodiment, the region of interest 30 is defined by the projection of the visible head surface 22 of the CHM 20 onto the image. The visible head surface 22 in turn is defined by the intersection of the head surface 21 with a boundary plane 24. The boundary plane 24 has a normal vector resulting from the cross product between a parallel vector to the X-axis of the camera 2 and a vector parallel to the centre axis 23 of the CHM 20. In other words, the boundary plane 24 is parallel to the X-axis and to the centre axis 24 (see the white-on-black numeral 6 in FIG. 5). The corners {P′T_{L}, P′_{TR}, P′_{BL}, P′_{BR}} of the visible head surface 22 of the CHM 20 are given by the furthermost intersected points between the model head surface 21 and the boundary plane 24, whereas the new region of interest 30 results from projecting the visible head surface 22 onto the image plane 2.1 (indicated by the white-on-black numeral 7 in FIG. 5).

The updated region of interest 30 again comprises non-facial regions like the neck region 33, the head top region 34, the head side region 35 etc. In the next loop, salient points from at least one of these non-facial regions 33-35 may be selected. For example, the head side region 35 now is closer to the center of the region of interest 30, making it likely that a salient point from this region will be selected, e.g. a feature of an ear.

1. A method for head pose estimation using a monocular camera, the method comprising:
providing an initial image frame recorded by the camera showing a head; and
performing at least one pose estimation loop with the following steps:
identifying and selecting of a plurality of salient points of the head having 2D coordinates in the initial image frame within a region of interest;
using a geometric head model of the head, determining 3D coordinates for the selected salient points corresponding to a head pose of the geometric head model;
providing an updated image frame recorded by the camera showing the head;
identifying within the updated image frame at least some previously selected salient points having updated 2D coordinates;
updating the head pose by determining updated 3D coordinates corresponding to the updated 2D coordinates using a perspective-n-point method; and
using the updated image frame as the initial image frame for the next pose updating loop.

2. The method of claim 1, wherein before performing the at least one pose updating loop, a distance between the camera and the head is determined.

3. The method of claim 1, wherein before performing the at least one pose updating loop, dimensions of the head model are determined.

4. The method of claim 1, wherein the head model is a cylindrical head model.

5. The method of claim 1, wherein a plurality of consecutive pose updating loops are performed.

6. The method of claim 1, wherein previously selected salient points are identified using optical flow.

7. The method of claim 1, wherein the 3D coordinates are determined by projecting 2D coordinates from an image plane of the camera onto a visible head surface.

8. The method of claim 1, wherein the visible head surface is determined by determining the intersection of a boundary plane with a model head surface.

9. The method of claim 1, wherein the boundary plane is parallel to an X-axis of the camera and a center axis of the cylindrical head model.

10. The method of claim 1, wherein the region of interest is defined by projecting the visible head surface onto the image plane.

11. The method of claim 1, wherein the salient points are selected based on an associated weight which depends on the distance to a border of the region of interest.

12. The method of claim 1, wherein the perspective-n-point method is performed based on the weight of the salient points.

13. The method of claim 1, wherein in each pose updating loop, the region of interest is updated.

14. A system for head pose estimation, comprising a monocular camera and a processing device, which is configured to:
receive an initial image frame recorded by the camera showing a head; and
perform at least one pose updating loop with the following steps:
identifying and selecting of a plurality of salient points of the head having 2D coordinates in the initial image frame within a region of interest;
determining 3D coordinates for the selected salient points using a geometric head model of the head, corresponding to a head pose;
receiving an updated image frame recorded by the camera showing the head;
identifying within the updated image frame at least some previously selected salient points having updated 2D coordinates;
updating the head pose by determining updated 3D coordinates corresponding to the updated 2D coordinates using a perspective-n-point method; and
using the updated image frame as the initial image frame for the next pose updating loop.

15. The system of claim 14, wherein the system is adapted to determine a distance between the camera and the head before performing the at least one pose updating loop.
